(19) United States
(12) Patent Application Publication
(10) Pub. No.: US 2026/0171714 A1
(43) Pub. Date: Jun. 18, 2026

(54) MAGNETIC BUILDING BLOCK

(71) Applicant: Jiangsu Youqixing Teaching Supplies Co., Ltd., Yangzhou (CN)

(72) Inventor: SHIXIN WU, Shenzhen (CN)

(21) Appl. No.: 19/536,422

(22) Filed: Feb. 11, 2026

Related U.S. Application Data
(63) Continuation-in-part of application No. 18/915,839, filed on Oct. 15, 2024.

(51) Int. Cl. H01R 13/62

(52) U.S. Cl. CPC H01R 13/6205

(57) ABSTRACT

Provided here is a magnetic building block including a main body and magnets. The main body is annularly connected end-to-end to form a plurality of corners provided with receiving units. The magnets are arranged within the receiving units. The receiving units are formed by blocking plates and side plates. Separating parts are arranged within the receiving units to separate the magnets. An upper cover and a lower cover are fitted onto the main body via insertion pins and insertion holes.

### CROSS-REFERENCE TO RELATED APPLICATIONS

This application is a continuation-in-part of U.S. application Ser. No. 18/915,839, filed on Oct. 15, 2024, the content of which is incorporated by reference herein.

### TECHNICAL FIELD

The present disclosure relates to the field of building blocks, and in particular, to a magnetic building block.

### BACKGROUND

Currently, most magnetic building blocks on the market mainly consist of an upper cover plate, a lower cover plate, and a plurality of side plates. Most existing magnetic building block products adopt this design, wherein the lower cover plate and the side plates are typically not integrally formed but are fixed by ultrasonic welding process. Although the ultrasonic welding process can provide high structural stability, it also exposes many problems in practical application. For example, the ultrasonic welding process generates significant noise and smoke, which not only affects the health of operators but also negatively impacts the environment. Furthermore, the ultrasonic welding process requires high positioning accuracy; the upper cover plate and the lower cover plate need to be precisely paired and positioned with the side plates one by one, resulting in a cumbersome assembly process and low production efficiency.

### SUMMARY

To overcome the deficiencies of the prior art, the present disclosure provides a magnetic building block, including a main body and magnets.

The main body is annularly connected end-to-end to form a plurality of corners. The plurality of corners are provided with receiving units.

The magnets are arranged in the receiving units.

The beneficial effects of the present disclosure are as follows. The present disclosure provides a magnetic building block, including a main body, the main body being annularly connected end-to-end and forming a plurality of corners, the plurality of corners being provided with receiving units; magnets, the magnets being arranged in the receiving units. With the above structure, the receiving units can stably accommodate the magnets and ensure that the magnets do not move out of the receiving units during use. The arrangement of a plurality of separating parts prevents a plurality of magnets in the same receiving unit from moving or colliding with each other, ensuring the stability of magnetic force and the adsorption effect. Furthermore, an upper cover and a lower cover are fitted onto the main body, simplifying the assembly process and improving production efficiency.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic structural view of Embodiment 1 of the present disclosure.

FIG. 2 is an exploded view of Embodiment 1 of the present disclosure.

FIG. 3 is a top view of Embodiment 1 of the present disclosure.

FIG. 4 is a bottom view of Embodiment 1 of the present disclosure.

FIG. 5 is a schematic structural view of a support part of Embodiment 1 of the present disclosure.

FIG. 6 is a schematic structural view of an insertion pin of Embodiment 1 of the present disclosure.

FIG. 7 is a cross-sectional view of Embodiment 1 of the present disclosure.

FIG. 8 is a schematic overall structural view of Embodiment 2 of the present disclosure.

FIG. 9 is an exploded structural view of Embodiment 2 of the present disclosure from one perspective.

FIG. 10 is an exploded structural view of Embodiment 2 of the present disclosure from another perspective.

FIG. 11 is a cross-sectional structural view of Embodiment 2 of the present disclosure from one perspective.

FIG. 12 is a cross-sectional structural view of Embodiment 2 of the present disclosure from another perspective.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

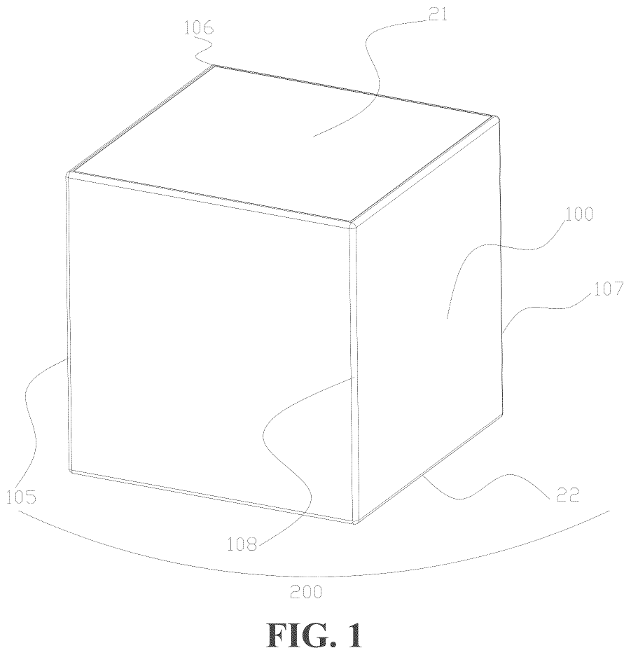

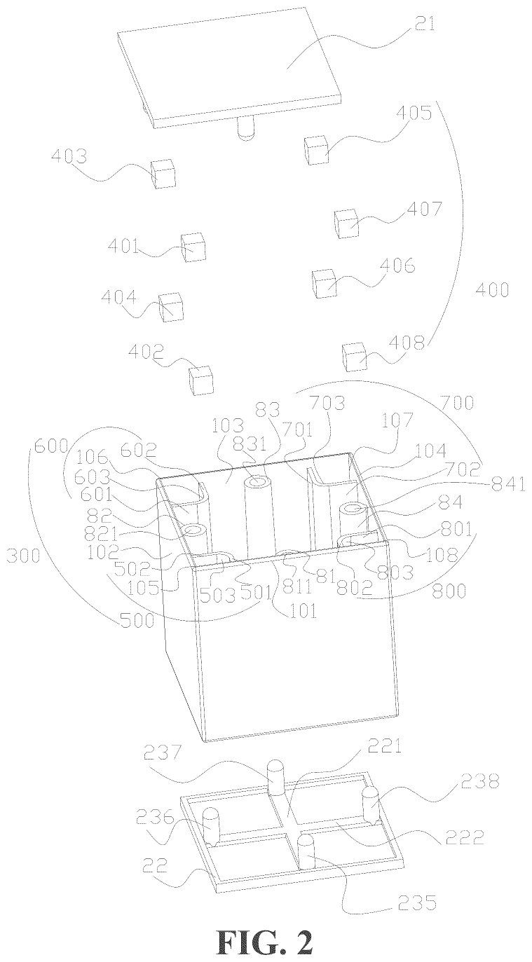

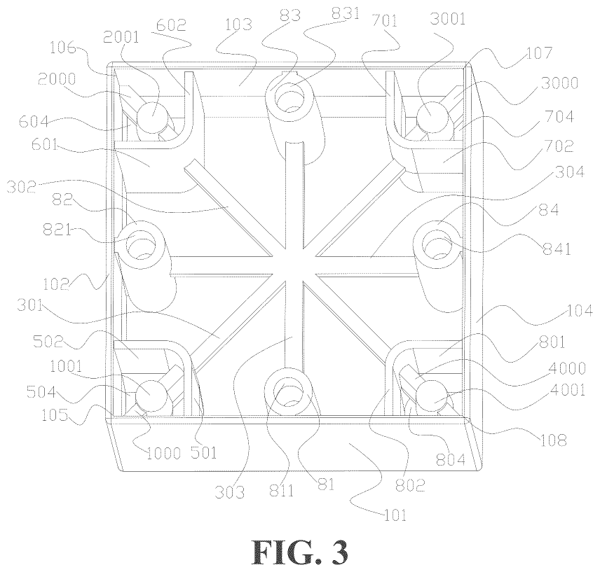

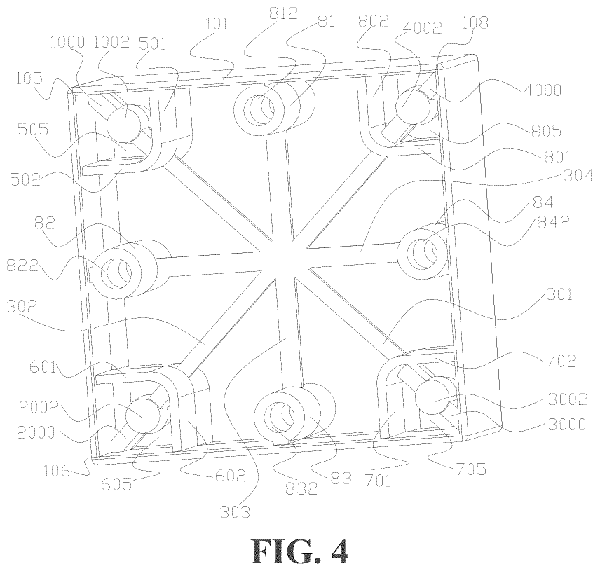

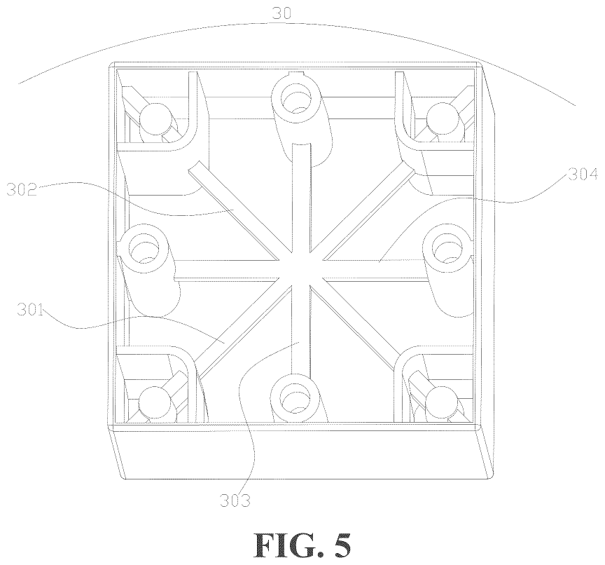

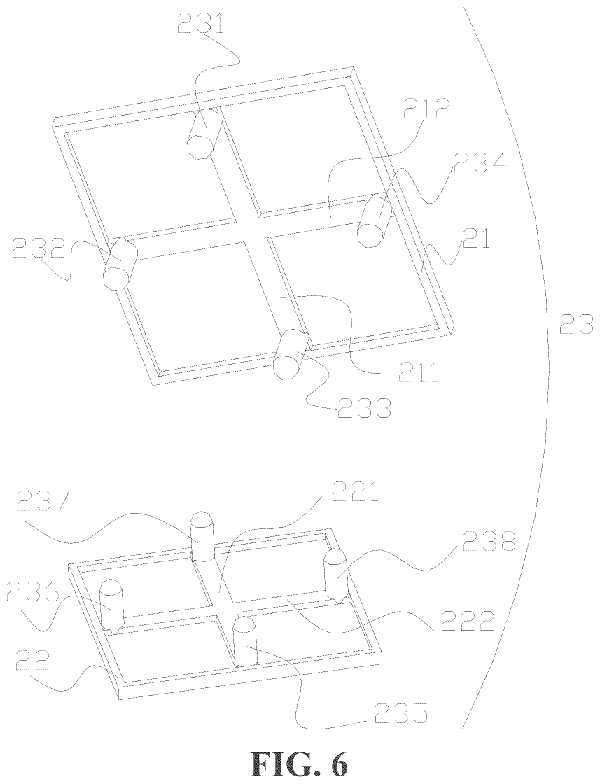

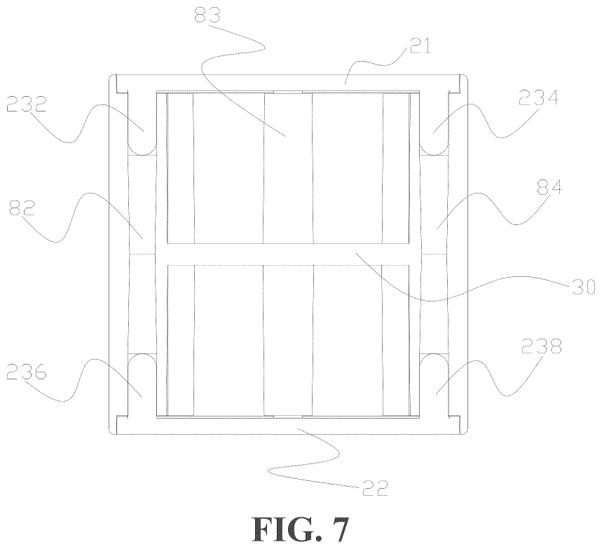

Embodiment 1: Referring to FIGS. 1 to 7, a magnetic building block includes a main body 100 and magnets 400. The main body 100 is annularly connected end-to-end and forms a plurality of corners 200. The plurality of corners 200 are provided with receiving units 300. The magnets 400 are arranged in the receiving units 300. With the above structure, the receiving units 300 can stably accommodate the magnets 400 and ensure that the magnets 400 do not move out of the receiving units 300 during use. The arrangement of a plurality of separating parts prevents a plurality of magnets 400 in the same receiving unit 300 from moving or colliding with each other, ensuring the stability of magnetic force and the adsorption effect. Furthermore, an upper cover 21 and a lower cover 22 are fitted onto the main body 100, simplifying the assembly process and improving production efficiency.

In this embodiment, the main body 100 includes a first side plate 101, a second side plate 102, a third side plate 103, and a fourth side plate 104. The first side plate 101, the second side plate 102, the third side plate 103, and the fourth side plate 104 are annularly connected end-to-end to form the main body 100. The connection between the first side plate 101 and the second side plate 102 forms a first corner 105. The connection between the second side plate 102 and the third side plate 103 forms a second corner 106. The connection between the third side plate 103 and the fourth side plate 104 forms a third corner 107. The connection between the fourth side plate 104 and the first side plate 101 forms a fourth corner 108. With the above structure, the main body 100 is formed by the first side plate 101, the second side plate 102, the third side plate 103, and the fourth side plate 104 being annularly connected end-to-end. The receiving units 300 are positioned at the four corners of the main body 100, ensuring the adsorption stability of the magnetic building block at different angles, making the magnetic force more uniform, and avoiding insufficient adsorption force in a single direction. Quite usefully, the external dimensions of the magnetic building block are 20 mm×20 mm×20 mm, ensuring suitability for children's hand operation and having sufficient strength and durability.

In this embodiment, the receiving units 300 include a first receiving unit 500 and a second receiving unit 600. The first receiving unit 500 is arranged at the first corner 105. The second receiving unit 600 is arranged at the second corner 106. The first receiving unit 500 includes a first blocking plate 501 and a second blocking plate 502. The connection between the first blocking plate 501 and the second blocking plate 502 forms a fifth corner 503. The fifth corner 503 is arranged opposite to the first corner 105. The first blocking plate 501 is connected to the first side plate 101. The second blocking plate 502 is connected to the second side plate 102. The first blocking plate 501, the second blocking plate 502, the first side plate 101, and the second side plate 102 enclose and form the first receiving unit 500. The second receiving unit 600 includes a third blocking plate 601 and a fourth blocking plate 602. The connection between the third blocking plate 601 and the fourth blocking plate 602 forms a sixth corner 603. The sixth corner 603 is arranged opposite to the second corner 106. The third blocking plate 601 is connected to the second side plate 102. The fourth blocking plate 602 is connected to the third side plate 103. The third blocking plate 601, the fourth blocking plate 602, the second side plate 102, and the third side plate 103 enclose and form the second receiving unit 600. With the above structure, the magnets 400 are respectively arranged in the first receiving unit 500 and the second receiving unit 600, ensuring the adsorption stability of the magnetic building block at different angles and making the magnetic force more uniform, thereby avoiding insufficient adsorption force in a single direction.

In this embodiment, the receiving units 300 further include a third receiving unit 700 and a fourth receiving unit 800. The third receiving unit 700 is arranged at the third corner 107. The fourth receiving unit 800 is arranged at the fourth corner 108. The third receiving unit 700 includes a fifth blocking plate 701 and a sixth blocking plate 702. The connection between the fifth blocking plate 701 and the sixth blocking plate 702 forms a seventh corner 703. The seventh corner 703 is arranged opposite to the third corner 107. The fifth blocking plate 701 is connected to the third side plate 103. The sixth blocking plate 702 is connected to the fourth side plate 104. The fifth blocking plate 701, the sixth blocking plate 702, the third side plate 103, and the fourth side plate 104 enclose and form the third receiving unit 700. The fourth receiving unit 800 includes a seventh blocking plate 801 and an eighth blocking plate 802. The connection between the seventh blocking plate 801 and the eighth blocking plate 802 forms an eighth corner 803. The eighth corner 803 is arranged opposite to the fourth corner 108. The seventh blocking plate 801 is connected to the fourth side plate 104. The eighth blocking plate 802 is connected to the first side plate 101. The seventh blocking plate 801, the eighth blocking plate 802, the fourth side plate 104, and the first side plate 101 enclose and form the fourth receiving unit 800. With the above structure, the magnets 400 are distributed in the first receiving unit 500, the second receiving unit 600, the third receiving unit 700, and the fourth receiving unit 800, forming a plurality of adsorption points, making the adsorption effect of the magnetic building block more uniform in different directions. Compared to a structure where magnets 400 are distributed only through the first receiving unit 500 and the second receiving unit 600, this embodiment further enhances the overall adsorption force and improves the stability and durability of the building block during assembly and use by additionally arranging the third receiving unit 700 and the fourth receiving unit 800.

In this embodiment, the main body 100 further includes a first separating part 1000. The first separating part 1000 is arranged in the first receiving unit 500 and separates the first receiving unit 500 into a first upper receiving cavity 504 and a first lower receiving cavity 505. The first upper receiving cavity 504 and the first lower receiving cavity 505 are in communication with each other. A first end of the first separating part 1000 is connected to the first corner 105. A second end of the first separating part 1000 is connected to the fifth corner 503. The main body 100 further includes a second separating part 2000. The second separating part 2000 is arranged in the second receiving unit 600 and separates the second receiving unit 600 into a second upper receiving cavity 604 and a second lower receiving cavity 605. The second upper receiving cavity 604 and the second lower receiving cavity 605 are in communication with each other. A first end of the second separating part 2000 is connected to the second corner 106. A second end of the second separating part 2000 is connected to the sixth corner 603. With the above structure, the design of the first separating part 1000 can effectively separate the magnets 400 in the first receiving unit 500, and the design of the second separating part 2000 can effectively separate the magnets 400 in the second receiving unit 600, preventing the magnets 400 from moving or colliding with each other during use.

In this embodiment, the main body 100 further includes a third separating part 3000. The third separating part 3000 is arranged in the third receiving unit 700 and separates the third receiving unit 700 into a third upper receiving cavity 704 and a third lower receiving cavity 705. The third upper receiving cavity 704 and the third lower receiving cavity 705 are in communication with each other. A first end of the third separating part 3000 is connected to the third corner 107. A second end of the third separating part 3000 is connected to the seventh corner 703. The main body 100 further includes a fourth separating part 4000. The fourth separating part 4000 is arranged in the fourth receiving unit 800 and separates the fourth receiving unit 800 into a fourth upper receiving cavity 804 and a fourth lower receiving cavity 805. The fourth upper receiving cavity 804 and the fourth lower receiving cavity 805 are in communication with each other. A first end of the fourth separating part 4000 is connected to the fourth corner 108. A second end of the fourth separating part 4000 is connected to the eighth corner 803. With the above structure, the design of the third separating part 3000 can effectively separate the magnets 400 in the third receiving unit 700, and the design of the fourth separating part 4000 can effectively separate the magnets 400 in the fourth receiving unit 800, preventing the magnets 400 from moving or colliding with each other during use.

In this embodiment, the magnets 400 include a first magnet 401 and a second magnet 402. The first magnet 401 is arranged in the first upper receiving cavity 504. The second magnet 402 is arranged in the first lower receiving cavity 505. An upper portion of the first separating part 1000 is provided with a first placement surface 1001. The first magnet 401 is arranged on the first placement surface 1001 and is limited within the first upper receiving cavity 504. A lower portion of the first separating part 1000 is provided with a second placement surface 1002. The second placement surface 1002 limits the second magnet 402 within the first lower receiving cavity 505. The magnets 400 include a third magnet 403 and a fourth magnet 404. The third magnet 403 is arranged in the second upper receiving cavity 604. The fourth magnet 404 is arranged in the second lower receiving cavity 605. An upper portion of the second separating part 2000 is provided with a third placement surface 2001. The third magnet 403 is arranged on the third placement surface 2001 and is limited within the second upper receiving cavity 604. A lower portion of the second separating part 2000 is provided with a fourth placement surface 2002. The fourth placement surface 2002 limits the fourth magnet 404 within the second lower receiving cavity 605. With the above structure, the first magnet 401 is arranged in the first upper receiving cavity 504, the second magnet 402 is arranged in the first lower receiving cavity 505; the third magnet 403 is arranged in the second upper receiving cavity 604, the fourth magnet 404 is arranged in the second lower receiving cavity 605; effectively separating the magnets 400 in the first receiving unit 500 and the second receiving unit 600, preventing the magnets 400 from moving or colliding with each other during use.

In this embodiment, the magnets 400 further include a fifth magnet 405 and a sixth magnet 406. The fifth magnet 405 is arranged in the third upper receiving cavity 704. The sixth magnet 406 is arranged in the third lower receiving cavity 705. An upper portion of the third separating part 3000 is provided with a fifth placement surface 3001. The fifth magnet 405 is arranged on the fifth placement surface 3001 and is limited within the third upper receiving cavity 704. A lower portion of the third separating part 3000 is provided with a sixth placement surface 3002. The sixth placement surface 3002 limits the sixth magnet 406 within the third lower receiving cavity 705. The magnets 400 further include a seventh magnet 407 and an eighth magnet 408. The seventh magnet 407 is arranged in the fourth upper receiving cavity 804. The eighth magnet 408 is arranged in the fourth lower receiving cavity 805. An upper portion of the fourth separating part 4000 is provided with a seventh placement surface 4001. The seventh magnet 407 is arranged on the seventh placement surface 4001 and is limited within the fourth upper receiving cavity 804. A lower portion of the fourth separating part 4000 is provided with an eighth placement surface 4002. The eighth placement surface 4002 limits the eighth magnet 408 within the fourth lower receiving cavity 805. With the above structure, the fifth magnet 405 is arranged in the third upper receiving cavity 704, the sixth magnet 406 is arranged in the third lower receiving cavity 705; the seventh magnet 407 is arranged in the fourth upper receiving cavity 804, the eighth magnet 408 is arranged in the fourth lower receiving cavity 805; effectively separating the magnets 400 in the third receiving unit 700 and the fourth receiving unit 800, preventing the magnets 400 from moving or colliding with each other during use.

In this embodiment, the main body 100 is further provided with a plurality of positioning posts 80. The plurality of positioning posts 80 are arranged opposite to each other. The plurality of positioning posts 80 include a first positioning post 81 and a second positioning post 82. The first positioning post 81 is arranged on an inner wall of the first side plate 101 and is positioned at a middle portion of the first side plate 101. The second positioning post 82 is arranged on an inner wall of the second side plate 102 and is positioned at a middle portion of the second side plate 102. A first end of the first positioning post 81 adjacent to an upper portion of the first side plate 101 defines a first insertion hole 811. A second end of the first positioning post 81 adjacent to a lower portion of the first side plate 101 defines a second insertion hole 812. A first end of the second positioning post 82 adjacent to an upper portion of the second side plate 102 defines a third insertion hole 821. A second end of the second positioning post 82 adjacent to a lower portion of the second side plate 102 defines a fourth insertion hole 822. With the above structure, the main body 100 is connected to the upper cover 21 and the lower cover 22 respectively through the first positioning post 81 and the second positioning post 82. The first insertion hole 811 on the first positioning post 81 is inserted with a first insertion pin 231 of the upper cover 21. The second insertion hole 812 on the first positioning post 81 is inserted with a fifth insertion pin 235 of the lower cover 22. The third insertion hole 821 on the second positioning post 82 is inserted with a second insertion pin 232 of the upper cover 21. The fourth insertion hole 822 on the second positioning post 82 is inserted with a sixth insertion pin 236 of the lower cover 22; facilitating the assembly of the upper cover 21 and the lower cover 22 with the main body 100.

In this embodiment, the plurality of positioning posts 80 include a third positioning post 83 and a fourth positioning post 84. The third positioning post 83 is arranged on an inner wall of the third side plate 103 and is positioned at a middle portion of the third side plate 103. The fourth positioning post 84 is arranged on an inner wall of the fourth side plate 104 and is positioned at a middle portion of the fourth side plate 104. A first end of the third positioning post 83 adjacent to an upper portion of the third side plate 103 defines a fifth insertion hole 831. A second end of the third positioning post 83 adjacent to a lower portion of the third side plate 103 defines a sixth insertion hole 832. A first end of the fourth positioning post 84 adjacent to an upper portion of the fourth side plate 104 defines a seventh insertion hole 841. A second end of the fourth positioning post 84 adjacent to a lower portion of the fourth side plate 104 defines an eighth insertion hole 842. With the above structure, the main body 100 is connected to the upper cover 21 and the lower cover 22 respectively through the third positioning post 83 and the fourth positioning post 84. The fifth insertion hole 831 on the third positioning post 83 is inserted with a third insertion pin 233 of the upper cover 21. The sixth insertion hole 832 on the third positioning post 83 is inserted with a seventh insertion pin 237 of the lower cover 22. The seventh insertion hole 841 on the fourth positioning post 84 is inserted with a fourth insertion pin 234 of the upper cover 21. The eighth insertion hole 842 on the fourth positioning post 84 is inserted with an eighth insertion pin 238 of the lower cover 22; facilitating the assembly of the upper cover 21 and the lower cover 22 with the main body 100.

In this embodiment, the main body 100 further includes an upper cover 21 and a lower cover 22. The upper cover 21 covers an upper opening of the annularly connected main body 100. The lower cover 22 covers a lower opening of the annularly connected main body 100. The upper cover 21 and the lower cover 22 are each provided with a plurality of insertion pins 23. The positions of the plurality of insertion pins 23 correspond to each other. The plurality of insertion pins 23 include the first insertion pin 231 and the second insertion pin 232. The first insertion pin 231 and the second insertion pin 232 are both arranged on a bottom portion of the upper cover 21. The first insertion pin 231 corresponds in position to the first insertion hole 811 and is inserted into the first insertion hole 811. The second insertion pin 232 corresponds in position to the third insertion hole 821 and is inserted into the third insertion hole 821. The plurality of insertion pins 23 include the third insertion pin 233 and the fourth insertion pin 234. The third insertion pin 233 and the fourth insertion pin 234 are both arranged on the bottom portion of the upper cover 21. The third insertion pin 233 corresponds in position to the fifth insertion hole 831 and is inserted into the fifth insertion hole 831. The fourth insertion pin 234 corresponds in position to the seventh insertion hole 841 and is inserted into the seventh insertion hole 841. With the above structure, the insertion pins 23 cooperate with the insertion holes to connect the main body 100 to the upper cover 21 and the lower cover 22 respectively, simplifying the assembly process and improving production efficiency.

In this embodiment, the upper cover 21 is further provided with a first crossbar 211 and a second crossbar 212. The first crossbar 211 and the second crossbar 212 are arranged crossing each other. A first end of the first crossbar 211 is connected to the first insertion pin 231. A second end of the first crossbar 211 is connected to the third insertion pin 233. A first end of the second crossbar 212 is connected to the second insertion pin 232. A second end of the second crossbar 212 is connected to the fourth insertion pin 234. With the above structure, the first crossbar 211 and the second crossbar 212 increase the compressive strength of the upper cover 21, reducing the risk of deformation of the upper cover 21.

In this embodiment, the plurality of insertion pins 23 include the fifth insertion pin 235 and the sixth insertion pin 236. The fifth insertion pin 235 and the sixth insertion pin 236 are both arranged on the lower cover 22. The fifth insertion pin 235 corresponds in position to the second insertion hole 812 and is inserted into the second insertion hole 812. The sixth insertion pin 236 corresponds in position to the fourth insertion hole 822 and is inserted into the fourth insertion hole 822. The plurality of insertion pins 23 include the seventh insertion pin 237 and the eighth insertion pin 238. The seventh insertion pin 237 and the eighth insertion pin 238 are both arranged on the lower cover 22. The seventh insertion pin 237 corresponds in position to the sixth insertion hole 832 and is inserted into the sixth insertion hole 832. The eighth insertion pin 238 corresponds in position to the eighth insertion hole 842 and is inserted into the eighth insertion hole 842. With the above structure, the insertion pins 23 cooperate with the insertion holes to connect the main body 100 to the upper cover 21 and the lower cover 22 respectively, simplifying the assembly process and improving production efficiency.

In this embodiment, the lower cover 22 is provided with a third crossbar 221 and a fourth crossbar 222. The third crossbar 221 and the fourth crossbar 222 are arranged crossing each other. A first end of the third crossbar 221 is connected to the fifth insertion pin 235. A second end of the third crossbar 221 is connected to the seventh insertion pin 237. A first end of the fourth crossbar 222 is connected to the sixth insertion pin 236. A second end of the fourth crossbar 222 is connected to the eighth insertion pin 238. With the above structure, the third crossbar 221 and the fourth crossbar 222 increase the compressive strength of the lower cover 22, reducing the risk of deformation of the lower cover 22.

In this embodiment, the main body 100 is further provided with a plurality of support parts 30. The plurality of support parts 30 are arranged crossing each other. The plurality of support parts 30 include a first support part 301 and a second support part 302. The first support part 301 and the second support part 302 are arranged crossing each other. A first end of the first support part 301 is connected to the fifth corner 503. A second end of the first support part 301 is connected to the seventh corner 703. A first end of the second support part 302 is connected to the sixth corner 603. A second end of the second support part 302 is connected to the eighth corner 803. The plurality of support parts 30 include a third support part 303 and a fourth support part 304. The third support part 303 and the fourth support part 304 are arranged crossing each other. A first end of the third support part 303 is connected to the first positioning post 81. A second end of the third support part 303 is connected to the third positioning post 83. A first end of the fourth support part 304 is connected to the second positioning post 82. A second end of the fourth support part 304 is connected to the fourth positioning post 84. With the above structure, the plurality of support parts 30 support the interior of the main body 100, enabling the main body 100 to have stronger support force and not deform. Furthermore, the plurality of support parts 30 also support the receiving units 300, increasing the support force of the receiving units 300.

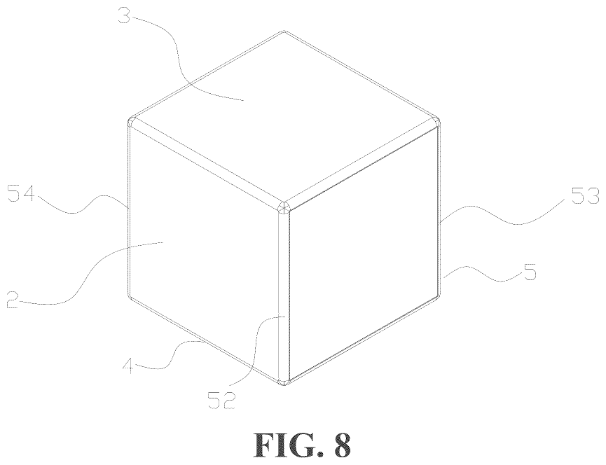

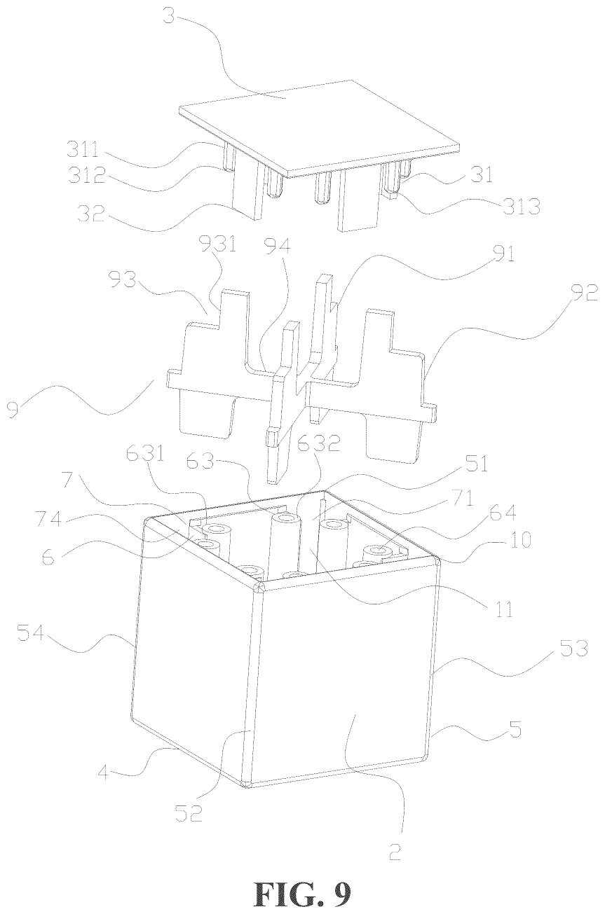

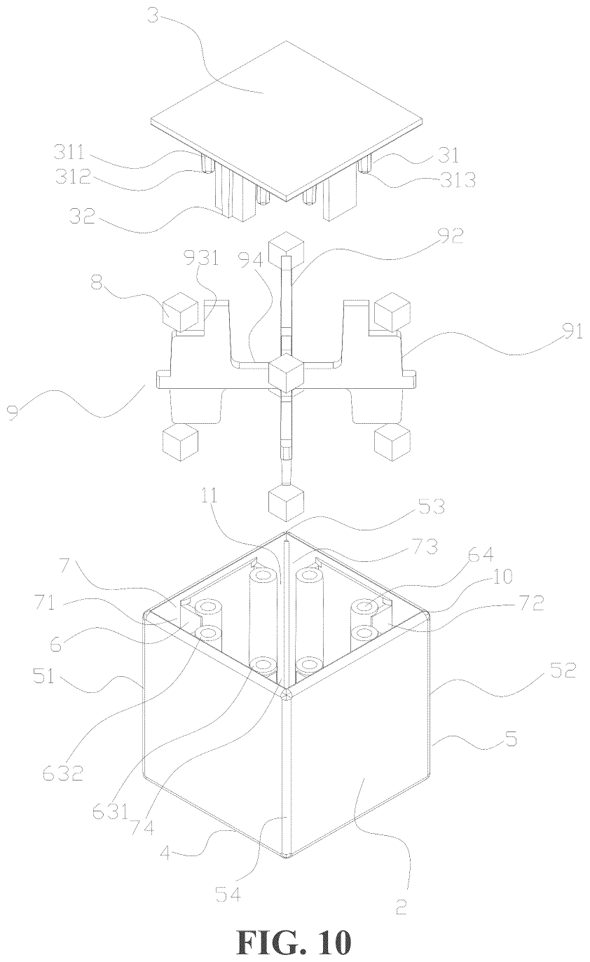

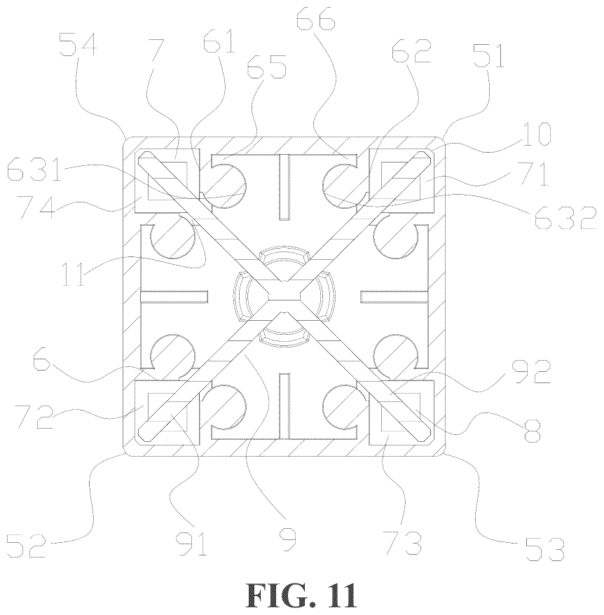

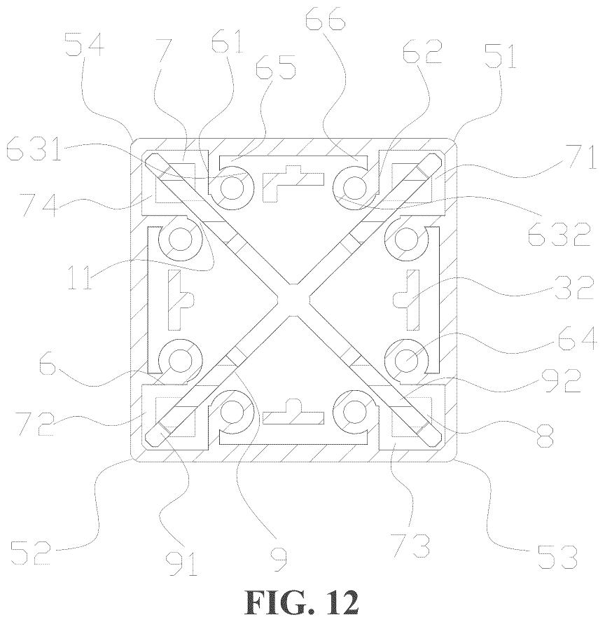

Embodiment 2: Referring to FIGS. 8 to 12, a magnetic building block comprises: four side plates 2, an upper cover plate 3, a lower cover plate 4, a plurality of magnetic blocks 8, and a separating part 9. The four side plates 2 are annularly connected end-to-end and form a plurality of corners 5. Two sides of each of the plurality of corners 5 are each provided with a blocking plate 6. The blocking plates 6 on the two sides of each corner 5 and the four side plates 2 together define a plurality of receiving chambers 7. Each of the plurality of blocking plates 6 defines an insertion hole 64. The plurality of magnetic blocks 8 are arranged in the plurality of receiving chambers 7. The separating part 9 is arranged to separate magnetic blocks 8 arranged in a same receiving chamber 7. The lower cover plate 4 covers a lower opening of the annularly connected four side plates 2 and is integrally formed with the side plates 2. The upper cover plate 3 is provided with insertion columns 31 adapted to the insertion holes 64. When the plurality of magnetic blocks 8 and the separating part 9 are installed in the plurality of receiving chambers 7, the insertion columns 31 are riveted into the insertion holes 64, so that the four side plates 2, the upper cover plate 3, and the lower cover plate 4 form an integral body.

Through the arrangement of the above structure, the plurality of receiving chambers 7 can stably accommodate the plurality of magnetic blocks 8 and the separating part 9, and ensure that the plurality of magnetic blocks 8 do not slide or fall out during use. The arrangement of the separating part 9 effectively prevents the plurality of magnetic blocks 8 in the plurality of receiving chambers 7 from moving or colliding with each other, ensuring the stability of magnetic force and the adsorption effect. Furthermore, the reasonable arrangement of the separating part 9 also improves the durability and stability of the overall structure. By integrally forming the lower cover plate 4 with the four side plates 2, the assembly process is simplified, avoiding additional mechanical assembly steps and improving production efficiency. Quite usefully, the riveted connection of the insertion columns 31 with the insertion holes 64 replaces the traditional ultrasonic welding process, avoiding noise and pollution that may be generated during production, and ensuring the firmness and use durability of the magnetic building block. Furthermore, the riveted connection also improves assembly accuracy, making the magnetic building block more environmentally friendly and efficient during production. Quite usefully, the external dimensions of the magnetic building block are 25 mm×25 mm×25 mm, ensuring suitability for children's hand operation and having sufficient compressive strength and durability.

In this embodiment, the upper cover plate 3 covers an upper opening of the annularly connected four side plates 2, and the lower cover plate 4 covers a lower opening of the annularly connected four side plates 2 and, at connection areas with the corners 5, forms cross angles 10. The plurality of magnetic blocks 8 are arranged in the plurality of receiving chambers 7 and are positioned at the cross angles 10. Through the arrangement of the above structure, the design of the cross angles 10 can concentrate the adsorption force of the plurality of magnetic blocks 8 on the edge areas of the magnetic building block, enabling multiple magnetic building blocks to be tightly adsorbed when connected together, improving the overall adsorption effect and stability. Quite usefully, the cross angles 10 are arranged at the connection between the upper cover plate 3 and the upper edges of the four side plates 2, as well as at the connection between the lower cover plate 4 and the lower edges of the four side plates 2. The plurality of magnetic blocks 8 are positioned adjacent to the cross angles 10, making the magnetic force more concentrated and improving the overall adsorption effect.

In this embodiment, the plurality of receiving chambers 7 include a first receiving chamber 71 and a second receiving chamber 72. The plurality of corners 5 include a first corner 51 and a second corner 52. The first corner 51 and the second corner 52 are arranged diagonally opposite. Two sides of the first corner 51 and two sides of the second corner 52 are each provided with a blocking plate 6. The blocking plates 6 and the side plates 2 on the two sides of the first corner 51 enclose and form the first receiving chamber 71. The blocking plates 6 and the side plates 2 on the two sides of the second corner 52 enclose and form the second receiving chamber 72. Both the first receiving chamber 71 and the second receiving chamber 72 are provided with magnetic blocks 8 and the separating part 9. Through the arrangement of the above structure, magnetic blocks 8 are respectively arranged in the first receiving chamber 71 and the second receiving chamber 72, ensuring the adsorption stability of the magnetic building block at different angles, and further optimizing the distribution among the magnetic blocks 8, making the magnetic force more uniform and avoiding insufficient adsorption force in a single direction.

In this embodiment, the plurality of receiving chambers 7 include a third receiving chamber 73 and a fourth receiving chamber 74. The plurality of corners 5 further include a third corner 53 and a fourth corner 54. The third corner 53 and the fourth corner 54 are arranged diagonally opposite and are arranged adjacent to the first corner 51 and the second corner 52. Two sides of the third corner 53 and two sides of the fourth corner 54 are each provided with a blocking plate 6. The blocking plates 6 and the side plates 2 on the two sides of the third corner 53 enclose and form the third receiving chamber 73. The side plates 2 on the two sides of the fourth corner 54 enclose and form the fourth receiving chamber 74. Both the third receiving chamber 73 and the fourth receiving chamber 74 are provided with magnetic blocks 8 from the plurality of magnetic blocks 8 and the separating part 9. Through the arrangement of the above structure, the magnetic blocks 8 are distributed in the first receiving chamber 71, the second receiving chamber 72, the third receiving chamber 73, and the fourth receiving chamber 74, forming a plurality of adsorption points, making the adsorption effect of the magnetic building block more uniform in different directions. Compared to a structure where magnetic blocks 8 are distributed only through the first receiving chamber 71 and the second receiving chamber 72, this embodiment further enhances the overall adsorption force and improves the stability and durability of the building block during assembly and use by additionally arranging the third receiving chamber 73 and the fourth receiving chamber 74.

In this embodiment, the separating part 9 includes a first plate part 91 and a second plate part 92. The first plate part 91 and the second plate part 92 are arranged in a cross shape. An opening 11 is defined between the two blocking plates 6 of the first receiving chamber 71. An opening 11 is defined between the two blocking plates 6 of the second receiving chamber 72. An opening 11 is defined between the two blocking plates 6 of the third receiving chamber 73. An opening 11 is defined between the two blocking plates 6 of the fourth receiving chamber 74. The blocking plates 6 are arranged enclosing with the side plates 2. Two side edges of the first plate part 91 and two side edges of the second plate part 92 can be respectively arranged in the first receiving chamber 71, the second receiving chamber 72, the third receiving chamber 73, and the fourth receiving chamber 74 through the openings 11. The plurality of magnetic blocks 8 are arranged at upper and lower ends of the first plate part 91 and at upper and lower ends of the second plate part 92. Through the arrangement of the above structure, the cross-shaped design of the separating part 9 can effectively fix the plurality of magnetic blocks 8 within the plurality of receiving chambers 7, preventing the magnetic blocks 8 from moving or colliding with each other during use. Simultaneously, the arrangement of the first receiving chamber 71, the second receiving chamber 72, the third receiving chamber 73, and the fourth receiving chamber 74 allows the plurality of magnetic blocks 8 to be reasonably separated and fixed, improving the firmness and adsorption effect of the overall structure. The design of the separating part 9 also simplifies the assembly process of the magnetic blocks, improving production efficiency.

In this embodiment, two ends of a side edge of the first plate part 91 adjacent to the upper cover plate 3 and two ends of a side edge of the second plate part 92 adjacent to the upper cover plate 3 are each provided with a notch 93 usable for installation of a magnetic block 8 from the plurality of magnetic blocks 8. Through the arrangement of the above structure, the notches 93 can provide a stable installation space for the magnetic blocks 8, ensuring the fixity of the magnetic blocks within the plurality of receiving chambers 7. Quite usefully, by arranging the notches 93 on the side edges of the first plate part 91 and the second plate part 92, displacement of the magnetic blocks can be reduced, improving the durability of the magnetic building block.

In this embodiment, the notches 93 are L-shaped, the side plate 2 and a side wall of a notch 93 define a receiving groove 931. A magnetic block 8 from the plurality of magnetic blocks 8 is arranged in the receiving groove 931. Through the arrangement of the above structure, the notches 93 can be L-shaped or U-shaped. Quite usefully, the L-shaped notches 93 can better fix the magnetic blocks 8 and also simplify processing and installation. The receiving groove 931 defined between the side wall of the L-shaped notch 93 and the side plate 2 provides additional support, enabling the magnetic block to be more stably embedded therein, preventing loosening or shifting during use. Compared to U-shaped notches, the design of L-shaped notches is more convenient for production and can reduce material usage without sacrificing stability, further improving the economic efficiency of the product.

In this embodiment, an upper end and a lower end where the first plate part 91 and the second plate part 92 cross are each further provided with a recess 94. Through the arrangement of the above structure, by arranging recesses 94 in the crossing area of the first plate part 91 and the second plate part 92, the recesses 94 can be U-shaped or V-shaped. Quite usefully, the recesses 94 are designed as U-shaped. This U-shaped design possesses significant advantages in effectively reducing material usage and lowering production costs. The U-shaped recesses 94 can reduce the amount of material required for the plate parts while maintaining structural strength. Compared to other shapes, the U-shaped recesses 94 have a larger internal space, and the internal structure can be optimized to reduce material usage without affecting the overall load-bearing capacity and stability of the magnetic building block.

In this embodiment, a side edge of each of the plurality of blocking plates 6 away from the side plate 2 is provided with a riveting column 63. The insertion hole 64 is defined at a top end of the riveting column 63. The insertion column 31 is riveted and pressed onto the riveting column 63 through the insertion hole 64. Through the arrangement of the above structure, the design of the riveting column 63 and the insertion hole 64 can effectively replace the traditional welding process, avoiding noise and smoke pollution generated during the welding process, while ensuring the stability of the overall structure of the building block. Quite usefully, two riveting columns 63 are arranged at each corner. The dual-riveting design greatly improves the compression resistance and firmness of the magnetic building block, ensuring the long-term durability of the magnetic building block during use.

In this embodiment, the upper cover plate 3 is further provided with a guide plate 32. The blocking plates 6 include a first blocking plate 61 and a second blocking plate 62, and the first blocking plate 61 and the second blocking plate 62 are arranged on the same side plate 2. The riveting columns 63 include a first riveting column 631 and a second riveting column 632. The first riveting column 631 is fixedly arranged on the first blocking plate 61. The second riveting column 632 is fixedly arranged on the second blocking plate 62. The first riveting column 631 and the second riveting column 632 are arranged adjacent to each other, so that the first riveting column 631, the first blocking plate 61, and the side plate 2 define a first sliding groove 65. The second riveting column 632, the second blocking plate 62, and the side plate 2 define a second sliding groove 66. An opening of the first sliding groove 65 and an opening of the second sliding groove 66 are arranged opposite to each other. Two side edges of the guide plate 32 can be slidably inserted into the first sliding groove 65 and the second sliding groove 66. Through the arrangement of the above structure, the guide plate 32 can slide smoothly in the first sliding groove 65 and the second sliding groove 66, ensuring precision and stability during connection and use of the structure. The guide plate 32 can be made of wear-resistant plastic materials such as polypropylene (PP), ABS plastic, or polycarbonate (PC). Quite usefully, the guide plate 32 is made of ABS plastic to ensure sufficient strength and good wear resistance, suitable for long-term use.

In this embodiment, the insertion column 31 is a cylinder 311. An outer side surface of the cylinder 311 is provided with a protrusion 312. Through the arrangement of the above structure, by arranging the protrusion 312 on the outer side surface of the cylinder 311, the friction force between the insertion column 31 and the insertion hole 64 can be increased, making the assembly firmer. The protrusion 312 provides additional stability, preventing the insertion column 31 from loosening during use, while enhancing the overall connection strength of the magnetic building block.

In this embodiment, the protrusion 312 is arranged along an extension direction of the cylinder 311. An end of the protrusion 312 adjacent to a top end of the cylinder 311 is provided with a cut surface 313. Through the arrangement of the above structure, quite usefully, the cut surface 313 is designed as an oblique cut, with an inclination angle ranging from 30° to 45°. This oblique cut design effectively reduces the frictional resistance generated when the insertion column 31 is inserted into the insertion hole 64. Through this design, the insertion column 31 aligns more smoothly with the insertion hole 64, reducing jamming during the alignment process.

In this embodiment, a top end of the cylinder 311 is configured as a hemispherical surface. Through the arrangement of the above structure, the smoothness of inserting the insertion column 31 into the insertion hole 64 can be effectively improved. The hemispherical surface design allows the insertion column 31 to enter the insertion hole 64 quickly and easily, avoiding jamming issues that may occur in traditional flat-top designs.

In this embodiment, the four side plates 2, the upper cover plate 3, and the lower cover plate 4 are made of ABS plastic. Through the arrangement of the above structure, the durability and impact resistance of the magnetic building block can be greatly improved. ABS plastic has excellent mechanical strength and wear resistance, and can withstand long-term use without easily deforming or breaking.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A magnetic building block, comprising:
a main body, the main body being annularly connected end-to-end and forming a plurality of corners, the plurality of corners being provided with receiving units; and
a plurality of magnets, the plurality of magnets being arranged in the receiving units.

2. The magnetic building block according to claim 1, wherein the main body comprises a first side plate, a second side plate, a third side plate and a fourth side plate, the first side plate, the second side plate, the third side plate and the fourth side plate being annularly connected end-to-end to form the main body; a connection between the first side plate and the second side plate forms a first corner, a connection between the second side plate and the third side plate forms a second corner, a connection between the third side plate and the fourth side plate forms a third corner, and a connection between the fourth side plate and the first side plate forms a fourth corner.

3. The magnetic building block according to claim 2, wherein the receiving units comprise a first receiving unit and a second receiving unit, the first receiving unit being arranged at the first corner, the second receiving unit being arranged at the second corner; the first receiving unit comprises a first blocking plate and a second blocking plate, a connection between the first blocking plate and the second blocking plate forms a fifth corner, the fifth corner being arranged opposite to the first corner; the first blocking plate is connected to the first side plate, the second blocking plate is connected to the second side plate; the first blocking plate, the second blocking plate, the first side plate and the second side plate enclose and form the first receiving unit; the second receiving unit comprises a third blocking plate and a fourth blocking plate, a connection between the third blocking plate and the fourth blocking plate forms a sixth corner, the sixth corner being arranged opposite to the second corner; the third blocking plate is connected to the second side plate, the fourth blocking plate is connected to the third side plate; the third blocking plate, the fourth blocking plate, the second side plate and the third side plate enclose and form the second receiving unit.

4. The magnetic building block according to claim 2, wherein the receiving units further comprise a third receiving unit and a fourth receiving unit, the third receiving unit being arranged at the third corner, the fourth receiving unit being arranged at the fourth corner; the third receiving unit comprises a fifth blocking plate and a sixth blocking plate, a connection between the fifth blocking plate and the sixth blocking plate forms a seventh corner, the seventh corner being arranged opposite to the third corner; the fifth blocking plate is connected to the third side plate, the sixth blocking plate is connected to the fourth side plate; the fifth blocking plate, the sixth blocking plate, the third side plate and the fourth side plate enclose and form the third receiving unit; the fourth receiving unit comprises a seventh blocking plate and an eighth blocking plate, a connection between the seventh blocking plate and the eighth blocking plate forms an eighth corner, the eighth corner being arranged opposite to the fourth corner; the seventh blocking plate is connected to the fourth side plate, the eighth blocking plate is connected to the first side plate; the seventh blocking plate, the eighth blocking plate, the fourth side plate and the first side plate enclose and form the fourth receiving unit.

5. The magnetic building block according to claim 3, wherein the main body further comprises a first separating part, the first separating part being arranged in the first receiving unit and separating the first receiving unit into a first upper receiving cavity and a first lower receiving cavity, the first upper receiving cavity and the first lower receiving cavity being in communication with each other; a first end of the first separating part is connected to the first corner, and a second end of the first separating part is connected to the fifth corner; the main body further comprises a second separating part, the second separating part being arranged in the second receiving unit and separating the second receiving unit into a second upper receiving cavity and a second lower receiving cavity, the second upper receiving cavity and the second lower receiving cavity being in communication with each other; a first end of the second separating part is connected to the second corner, and a second end of the second separating part is connected to the sixth corner.

6. The magnetic building block according to claim 4, wherein the main body further comprises a third separating part, the third separating part being arranged in the third receiving unit and separating the third receiving unit into a third upper receiving cavity and a third lower receiving cavity, the third upper receiving cavity and the third lower receiving cavity being in communication with each other; a first end of the third separating part is connected to the third corner, and a second end of the third separating part is connected to the seventh corner; the main body further comprises a fourth separating part, the fourth separating part being arranged in the fourth receiving unit and separating the fourth receiving unit into a fourth upper receiving cavity and a fourth lower receiving cavity, the fourth upper receiving cavity and the fourth lower receiving cavity being in communication with each other; a first end of the fourth separating part is connected to the fourth corner, and a second end of the fourth separating part is connected to the eighth corner.

7. The magnetic building block according to claim 5, wherein the plurality of magnets comprise a first magnet and a second magnet, the first magnet being arranged in the first upper receiving cavity, the second magnet being arranged in the first lower receiving cavity; an upper portion of the first separating part is provided with a first placement surface, the first magnet being arranged on the first placement surface and being limited within the first upper receiving cavity; a lower portion of the first separating part is provided with a second placement surface, and the second placement surface is configured for limiting the second magnet within the first lower receiving cavity.

8. The magnetic building block according to claim 5, wherein the plurality of magnets comprise a third magnet and a fourth magnet, the third magnet being arranged in the second upper receiving cavity, the fourth magnet being arranged in the second lower receiving cavity; an upper portion of the second separating part is provided with a third placement surface, the third magnet being arranged on the third placement surface and being limited within the second upper receiving cavity; a lower portion of the second separating part is provided with a fourth placement surface, and the fourth placement surface is configured for limiting the fourth magnet within the second lower receiving cavity.

9. The magnetic building block according to claim 6, wherein the plurality of magnets further comprise a fifth magnet and a sixth magnet, the fifth magnet being arranged in the third upper receiving cavity, the sixth magnet being arranged in the third lower receiving cavity; an upper portion of the third separating part is provided with a fifth placement surface, the fifth magnet being arranged on the fifth placement surface and being limited within the third upper receiving cavity; a lower portion of the third separating part is provided with a sixth placement surface, and the sixth placement surface is configured for limiting the sixth magnet within the third lower receiving cavity.

10. The magnetic building block according to claim 6, wherein the plurality of magnets further comprise a seventh magnet and an eighth magnet, the seventh magnet being arranged in the fourth upper receiving cavity, the eighth magnet being arranged in the fourth lower receiving cavity; an upper portion of the fourth separating part is provided with a seventh placement surface, the seventh magnet being arranged on the seventh placement surface and being limited within the fourth upper receiving cavity; a lower portion of the fourth separating part is provided with an eighth placement surface, and the eighth placement surface is configured for limiting the eighth magnet within the fourth lower receiving cavity.

11. The magnetic building block according to claim 2, wherein the main body is further provided with a plurality of positioning posts, the plurality of positioning posts being arranged opposite to each other; the plurality of positioning posts comprise a first positioning post and a second positioning post, the first positioning post being arranged on an inner wall of the first side plate and positioned at a middle portion of the first side plate, the second positioning post being arranged on an inner wall of the second side plate and positioned at a middle portion of the second side plate; a first end of the first positioning post adjacent to an upper portion of the first side plate defines a first insertion hole, a second end of the first positioning post adjacent to a lower portion of the first side plate defines a second insertion hole; a first end of the second positioning post adjacent to an upper portion of the second side plate defines a third insertion hole, a second end of the second positioning post adjacent to a lower portion of the second side plate defines a fourth insertion hole.

12. The magnetic building block according to claim 11, wherein the plurality of positioning posts further comprise a third positioning post and a fourth positioning post, the third positioning post being arranged on an inner wall of the third side plate and positioned at a middle portion of the third side plate, the fourth positioning post being arranged on an inner wall of the fourth side plate and positioned at a middle portion of the fourth side plate; a first end of the third positioning post adjacent to an upper portion of the third side plate defines a fifth insertion hole, a second end of the third positioning post adjacent to a lower portion of the third side plate defines a sixth insertion hole; a first end of the fourth positioning post adjacent to an upper portion of the fourth side plate defines a seventh insertion hole, a second end of the fourth positioning post adjacent to a lower portion of the fourth side plate defines an eighth insertion hole.

13. The magnetic building block according to claim 12, wherein the main body further comprises an upper cover and a lower cover, the upper cover covering an upper opening of the annularly connected main body, the lower cover covering a lower opening of the annularly connected main body; the upper cover and the lower cover are each provided with a plurality of insertion pins, positions of the plurality of insertion pins corresponding to each other; the plurality of insertion pins comprise a first insertion pin and a second insertion pin, the first insertion pin and the second insertion pin being arranged on a bottom portion of the upper cover; the first insertion pin corresponds in position to the first insertion hole and is inserted into the first insertion hole, and the second insertion pin corresponds in position to the third insertion hole and is inserted into the third insertion hole.

14. The magnetic building block according to claim 13, wherein the plurality of insertion pins further comprise a third insertion pin and a fourth insertion pin, the third insertion pin and the fourth insertion pin being arranged on the bottom portion of the upper cover; the third insertion pin corresponds in position to the fifth insertion hole and is inserted into the fifth insertion hole, and the fourth insertion pin corresponds in position to the seventh insertion hole and is inserted into the seventh insertion hole.

15. The magnetic building block according to claim 14, wherein the upper cover is further provided with a first crossbar and a second crossbar, the first crossbar and the second crossbar being arranged crossing each other; a first end of the first crossbar is connected to the first insertion pin, and a second end of the first crossbar is connected to the third insertion pin; a first end of the second crossbar is connected to the second insertion pin, and a second end of the second crossbar is connected to the fourth insertion pin.

16. The magnetic building block according to claim 13, wherein the plurality of insertion pins further comprise a fifth insertion pin and a sixth insertion pin, the fifth insertion pin and the sixth insertion pin being arranged on the lower cover; the fifth insertion pin corresponds in position to the second insertion hole and is inserted into the second insertion hole, and the sixth insertion pin corresponds in position to the fourth insertion hole and is inserted into the fourth insertion hole.

17. The magnetic building block according to claim 16, wherein the plurality of insertion pins further comprise a seventh insertion pin and an eighth insertion pin, the seventh insertion pin and the eighth insertion pin being arranged on the lower cover; the seventh insertion pin corresponds in position to the sixth insertion hole and is inserted into the sixth insertion hole, and the eighth insertion pin corresponds in position to the eighth insertion hole and is inserted into the eighth insertion hole.

18. The magnetic building block according to claim 17, wherein the lower cover is provided with a third crossbar and a fourth crossbar, the third crossbar and the fourth crossbar being arranged crossing each other; a first end of the third crossbar is connected to the fifth insertion pin, and a second end of the third crossbar is connected to the seventh insertion pin; a first end of the fourth crossbar is connected to the sixth insertion pin, and a second end of the fourth crossbar is connected to the eighth insertion pin.

19. The magnetic building block according to claim 12, wherein the main body is further provided with a plurality of support parts, the plurality of support parts being arranged crossing each other; the plurality of support parts comprise a first support part and a second support part, the first support part and the second support part being arranged crossing each other; a first end of the first support part is connected to a fifth corner, and a second end of the first support part is connected to a seventh corner; a first end of the second support part is connected to a sixth corner, and a second end of the second support part is connected to an eighth corner.

20. The magnetic building block according to claim 19, wherein the plurality of support parts comprise a third support part and a fourth support part, the third support part and the fourth support part being arranged crossing each other; a first end of the third support part is connected to the first positioning post, and a second end of the third support part is connected to the third positioning post; a first end of the fourth support part is connected to the second positioning post, and a second end of the fourth support part is connected to the fourth positioning post.
